(19) United States
(12) Patent Application Publication
(10) Pub. No.: US 2014/0265650 A1
(43) Pub. Date: Sep. 18, 2014

(54) HORIZONTAL LINEAR VIBRATOR

(71) Applicant: SAMSUNG ELECTRO-MECHANICS CO., LTD., SUWON (KR)

(72) Inventor: Young Jae JEON, SUWON (KR)

(21) Appl. No.: 13/943,202

(22) Filed: Jul. 16, 2013

(30) Foreign Application Priority Data
Mar. 13, 2013 (KR) 10-2013-0026516

(51) Int. Cl. H02K 33/00

(52) U.S. Cl. CPC H02K 33/00
USPC 310/25

(57) ABSTRACT

There is provided a horizontal linear vibrator including a housing, a mass member movably mounted within the housing in a length direction thereof, a coil member mounted in the housing, a magnet member mounted in the mass member and interacting with the coil member to generate a magnetic field so as to enable movement of the mass member, an elastic member mounted in the housing and applying force in the same direction as or an opposite direction to a moving direction of the mass member, and a bearing member disposed between the mass member and the housing to enable a sliding motion of the mass member relative to the housing.

This application claims the priority of Korean Patent Application No. 10-2013-0026516 filed on Mar. 13, 2013, in the Korean Intellectual Property Office, the disclosure of which is incorporated herein by reference.

### BACKGROUND OF THE INVENTION

1. Field of the Invention

The present invention relates to a linear vibrator able to be mounted in small electronic devices, and more particularly, to implementation of a small and light horizontal linear vibrator.

2. Description of the Related Art

In general, one of the fundamental functions of communications devices is the call notification function. Examples thereof may include a sound generation function, such as melody or bell and a vibration function, in which vibrations are transferred to devices.

Among these functions, the vibration function has mainly been used to prevent a melody or a bell provided through a speaker of a device from inconveniencing others.

In order to implement the vibration function, generally, vibratory force, generated by driving a small vibration motor, is transferred to a case to allow devices to be vibrated.

In recent times, as demand for small and multifunctional mobile phone has increased, a touch screen type display device, or the like, has been frequently adopted. However, there is a need to increasingly improve vibration motors to have a function of generating vibrations when the display device is touched, and the like.

Vibration motors used in existing mobile phones employ a method of generating a torque to rotate a rotating part of an unbalance mass so as to obtain mechanical vibrations. In this case, the torque is mainly generated by a structure in which a current commutated through a contact between a brush and a commutator is supplied to a rotor coil.

However, a brush-type structure using the commutator causes mechanical friction and generates electrical sparks, while the brush passes through a gap between segments of the commutator at the time of rotating the motor and therefore wears the brush and the commutator, thereby shortening the lifespan of the motor.

Further, rotational inertia may be present in the brush-type structure when voltage is applied to the motor, thus requiring a relatively long period of time to reach a targeted vibration amount, and therefore, it may be difficult to implement an amount of vibrations appropriate for personal digital assistants (PDAs), and the like, to which the touch screen is applied.

Therefore, in order to improve lifespan and response characteristics of the display device, a linear vibrator generating vibrations through a scheme other than a rotational scheme has been used.

Such a linear vibrator uses a spring mounted therein and a mass body coupled to the spring, having a determined resonance frequency and excited by electromagnetic force, to thereby generate vibrations.

However, since the linear vibrator may be vibrated vertically and only generates vibrations in the case in which the linear vibrator moves, securing a vertical displacement of the mass body mounted therein, the linear vibrator may have a restriction in terms of a thickness.

Further, since the thickness of the linear vibrator increases with the increase in the amount of vibrations generated thereby, PDAs require a large space to allow the linear vibrator to be mounted therein, such that it is difficult to miniaturize the linear vibrator.

Meanwhile, as the related art, there are provided Patent Documents 1 and 2. Both of Patent Documents 1 and 2 disclose a linear vibrator. However, Patent Document 1 does not have a configuration allowing for a stable reciprocating motion to be induced in a vibration part, such that it is difficult to obtain a constant vibrational frequency. On the other hand, according to Patent Document 2, a constant vibrational frequency may be obtained by a shaft guiding a reciprocating motion of the vibration part. However, according to Patent Document 2, since the shaft and the vibration part may not be easily assembled and the shaft may be easily deformed due to external impacts, the miniaturization and lightness of the linear vibrator may not be easily implemented and the linear vibrator may be inappropriate for portable electronic devices to which external impacts are frequently applied.

### RELATED ART DOCUMENT

(Patent Document 1) KR10-1152417 B1
(Patent Document 2) JP2012-016153 A

### SUMMARY OF THE INVENTION

An aspect of the present invention provides a horizontal linear vibrator which can be easily miniaturized, is reduced in weight and can withstand external impacts.

According to an aspect of the present invention, there is provided a horizontal linear vibrator, including: a housing;

a mass member movably mounted within the housing in a length direction thereof; a coil member mounted in the housing; a magnet member mounted in the mass member and interacting with the coil member to generate a magnetic field so as to enable movement of the mass member; an elastic member mounted in the housing and applying force in the same direction as or an opposite direction to a moving direction of the mass member; and a bearing member disposed between the mass member and the housing to enable a sliding motion of the mass member relative to the housing.

The elastic member may be a coil spring.

The elastic member may include: a first spring connecting one end of the housing to one end of the mass member; and a second spring connecting the other end of the housing to the other end of the mass member.

The first spring and the second spring may have different spring constants.

The housing may have a cylindrical shape having a circular cross-section, and the mass member may have a cylindrical shape having a circular cross-section.

The magnet member may be disposed to be deflected in one direction from a center of a magnetic field of the coil member to provide a deflected magnetic field to the coil member in a state in which the mass member stops.

According to an aspect of the present invention, there is provided a horizontal linear vibrator, including: a housing; a mass member movably mounted within the housing in a length direction thereof; a magnet member mounted in the housing; a coil member mounted in the mass member and interacting with the magnet member to generate a magnetic field so as to enable movement of the mass member; an elastic member mounted in the housing and applying force in the same direction as or an opposite direction to a moving direction of the mass member; and a bearing member disposed between the mass member and the housing to enable a sliding motion of the mass member relative to the housing.

The elastic member may be a coil spring.

The elastic member may include: a first spring connecting one end of the housing to one end of the mass member; and a second spring connecting the other end of the housing to the other end of the mass member.

The first spring and the second spring may have different spring constants.

The housing may have a cylindrical shape having a circular cross-section and the mass member may have a cylindrical shape having a circular cross-section.

The magnet member may be disposed to be deflected in one direction from a center of a magnetic field of the coil member to provide a deflected magnetic field to the coil member in a state in which the mass member stops.

According to an aspect of the present invention, there is provided a horizontal linear vibrator, including: a housing provided with a groove extending lengthily in a length direction; amass member movably mounted within the housing in a length direction thereof and provided with a protrusion inserted into the groove; a coil member mounted in the housing; a magnet member mounted in the mass member and interacting with the coil member to generate a magnetic field so as to enable movement of the mass member; and an elastic member mounted in the housing and applying force in the same direction as or an opposite direction to a moving direction of the mass member.

The elastic member may be a coil spring.

The elastic member may include: a first spring connecting one end of the housing to one end of the mass member; and a second spring connecting the other end of the housing to the other end of the mass member.

The first spring and the second spring may have different spring constants.

The housing may have a cylindrical shape having a circular cross-section and the mass member may have a cylindrical shape having a circular cross-section.

The magnet member may be disposed to be deflected in one direction from a center of a magnetic field of the coil member to provide a deflected magnetic field to the coil member in a state in which the mass member stops.

According to an aspect of the present invention, there is provided a horizontal linear vibrator, including: a housing having a receiving space extending in a length direction; amass member mounted in the receiving space and movable along the length direction; a coil member mounted in the housing; a magnet member mounted in the mass member and interacting with the coil member to generate a magnetic field so as to enable movement of the mass member; and an elastic member mounted in the housing and applying force in the same direction as or an opposite direction to a moving direction of the mass member, wherein the receiving space has an asymmetrical cross-section or an oval or polygonal cross-section and the mass member has a cross-sectional shape coinciding with a section of the receiving space.

The elastic member may be a coil spring.

The elastic member may include: a first spring connecting one end of the housing to one end of the mass member; and a second spring connecting the other end of the housing to the other end of the mass member.

The first spring and the second spring may have different spring constants.

The magnet member may be disposed to be deflected in one direction from a center of a magnetic field of the coil member to provide a deflected magnetic field to the coil member in a state in which the mass member stops.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a horizontal linear vibrator according to a first embodiment of the present invention;

FIG. 2 is a cross-sectional view taken along line A-A of the horizontal linear vibrator illustrated in FIG. 1;

FIG. 3 is a cross-sectional view illustrating another form of the horizontal linear vibrator illustrated in FIG. 1;

FIG. 4 is a cross-sectional view of a horizontal linear vibrator according to a second embodiment of the present invention;

FIG. 5 is a cross-sectional view of a horizontal linear vibrator according to a third embodiment of the present invention;

FIG. 6 is a cross-sectional view taken along line B-B of the horizontal linear vibrator illustrated in FIG. 5;

FIGS. 7 and 8 are cross-sectional views of another form of the horizontal linear vibrator taken along line B-B illustrated in FIG. 5;

FIG. 9 is a cross-sectional view of a horizontal linear vibrator according to a fourth embodiment of the present invention;

FIG. 10 is a cross-sectional view taken along line C-C of the horizontal linear vibrator illustrated in FIG. 9; and

FIGS. 11 and 12 are cross-sectional views of another form of the horizontal linear vibrator taken along line C-C illustrated in FIG. 9.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

FIG. 1 is a cross-sectional view of a horizontal linear vibrator according to a first embodiment of the present invention; FIG. 2 is a cross-sectional view taken along line A-A of the horizontal linear vibrator illustrated in FIG. 1; FIG. 3 is a cross-sectional view illustrating another form of the horizontal linear vibrator illustrated in FIG. 1; FIG. 4 is a cross-sectional view of a horizontal linear vibrator according to a second embodiment of the present invention; FIG. 5 is a cross-sectional view of a horizontal linear vibrator according to a third embodiment of the present invention; FIG. 6 is a cross-sectional view taken along line B-B of the horizontal linear vibrator illustrated in FIG. 5; FIGS. 7 and 8 are cross-sectional views of another form of the horizontal linear vibrator taken along line B-B illustrated in FIG. 5; FIG. 9 is a cross-sectional view of a horizontal linear vibrator according to a fourth embodiment of the present invention; FIG. 10 is a cross-sectional view taken along line C-C of the horizontal linear vibrator illustrated in FIG. 9; and FIGS. 11 and 12 are cross-sectional views of another form of the horizontal linear vibrator taken along line C-C illustrated in FIG. 9.

The horizontal linear vibrator according to a first embodiment of the present invention will be described with reference FIGS. 1 through 3.

A horizontal linear vibrator 100 according to the embodiment of the present invention may include a housing 110, a mass member 120, a magnet member 130, and a coil member 140. In addition, the horizontal linear vibrator 100 may further include an elastic member 150 and a bearing member 160.

The housing 110 has a receiving space 112 and may be formed to lengthily extend in one direction. For example, the housing 110 may have a hollow cylindrical shape (see FIG. 2). However, the shape of the housing 110 is not limited to the cylindrical shape. In other words, the housing 110 may have a polygonal shape or other shapes, as necessary.

The housing 110 may be formed of a material having sufficient rigidity to protect members disposed in the receiving space 112 from external impact. For example, the housing 110 may be formed of a metal or a plastic material. However, the housing 110 is not only formed of the above-mentioned materials, but may be formed of other materials, as needed.

The housing 110 may be formed of a plurality of members. In other words, the housing 110 may be formed by coupling two members which are symmetrical, relative to each other. By this configuration, the plurality of members may easily be mounted in the receiving space 112 of the housing 110 and the mounted members may easily be replaced and exchanged with other members.

The mass member 120 may be mounted in the receiving space 112 of the housing 110. In other words, the mass member 120 has a size smaller than that of the housing 110, and therefore may be completely received in the receiving space 112. For reference, according to the embodiment of the present invention, the mass member 120 has a cylindrical shape which substantially coincides with the receiving space 112 of the housing 110. However, the shape of the mass member 120 is not limited to a cylinder, but may be changed variously, as needed.

The mass member 120 may move in the receiving space 112. In other words, the mass member 120 may move in a reciprocal manner in a length direction of the housing 110. To this end, a length L1 of the mass member 120 may be shorter than a length of the housing 110 or a length L2 of the receiving space 112. In this case, a length deviation L2-L1 between the length L2 of the receiving space 112 and the length L1 of the mass member 120 may be determined depending on a type of a natural vibrational frequency of the horizontal linear vibrator 100. For example, when the natural vibrational frequency having relatively large amplitude is required, the length deviation L2-L1 may be large and when the natural vibrational frequency having relatively small amplitude is required, the length deviation L2-L1 may be small.

The mass member 120 may have a mass required to induce the vibrations of the horizontal linear vibrator 100. In other words, the mass of the mass member 120 may be changed depending on the natural vibrational frequency of the horizontal linear vibrator 100. For example, when the natural vibrational frequency in a high frequency band is required, the mass of the mass member 120 may be decreased, and when the natural vibrational frequency in a low frequency band is required, the mass of the mass member 120 may be increased.

The mass member 120 may be formed of a metal or a rubber material. The metal may be used in increasing a size of amass with a small size and the rubber material may be used in relieving a breakage phenomenon due to impact between the housing 110 and the mass member 120.

The magnet member 130 may be mounted in the mass member 120. In other words, the magnet member 130 may be mounted on a circumference of the mass member 120 (see FIG. 2). To this end, the circumference of the mass member 120 may be provided with a groove 122 in which the magnet member 130 is mounted. However, the circumference of the mass member 120 is not necessarily provided with the groove 122. For example, the magnet member 130 may be attached to the circumference of the mass member 120 by an adhesive.

Both ends (horizontal direction based on FIG. 1) of the magnet member 130 may have different polarities. For example, one end of the magnet member 130 may be a first polarity (N pole) and the other end thereof may be a second polarity (S pole). The magnet member 130, so disposed, may form a magnetic force, along with the coil member 140 to move the mass member 120 in a reciprocal manner in a length direction (horizontal direction based on FIG. 1) of the housing 110.

As illustrated in FIG. 1, the magnet member 130 may be formed to be wider than the coil member 140. The magnet member 130, so formed, may continuously face the coil member 140 during the reciprocating motion of the mass member 120 to form the magnetic force.

Meanwhile, as illustrated in FIG. 3, the magnet member 130 may be disposed to be deflected in one direction with respect to the coil member 140 in a state in which the mass member 120 stops. In other words, a center line C1-C1 of the magnet member 130 may be disposed to be deflected with a center line C2-C2 of the coil member 140 at a predetermined distance. The structure, so disposed, generates a magnetic field deflected in one direction between the magnet member 130 and the coil member 140, which may be applied to the case of starting the mass member 120 in the stopped state.

The coil member 140 may be mounted in the housing 110. In other words, the coil member 140 may be mounted on an inner circumferential surface of the housing 110 and may be disposed at a position facing the magnet member 130 in the stop state of the mass member 120 (see FIGS. 1 and 2).

The coil member 140 may be connected to an external power supply. In other words, the coil member 140 may have a current applied thereto from the external power supply to generate a predetermined magnetic field.

The so configured coil member 140 may alternately generate a magnetic field which coincides with or does not coincide with the magnetic field of the magnet member 130 depending on a supply direction of current, thereby reciprocally moving the mass member 120.

The elastic member 150 may be mounted in the receiving space 112 of the housing 110 and may provide a predetermined elastic force in a one-axis direction (horizontal direction based on FIG. 1). To this end, the elastic member 150 may have a spring shape. In other words, the elastic member 150 may be a coil spring.

The elastic member 150 may be disposed between one end of the housing 110 and one end of the mass member 120 and between the other end of the housing 110 and the other end of the mass member 120. The elastic member 150, so disposed, may provide elastic force in a direction opposite to a moving direction of the mass member 120. For example, when the mass member 120 moves in a first direction (a left direction, based on FIG. 1), the elastic member 150 may apply the elastic force to the mass member 120 in the second direction (a right direction, based on FIG. 1), and when the mass member 120 moves in a second direction, the elastic member 150 may apply the elastic force to the mass member 120 in the first direction.

Further, the elastic member 150 may prevent the mass member 120 from colliding with the housing 110. In other words, the elastic member 150 may prevent both ends of the mass member 120 from colliding with left and right ends of the housing 110 due to a sudden motion of the mass member 120.

Meanwhile, the elastic members 150 disposed at both ends of the mass member 120 may have different elastic moduli as illustrated in FIG. 3. In other words, a first coil spring 152 disposed at one side of the mass member 120 may have a first spring constant and a second coil spring 154 disposed at the other side thereof may have a second spring constant. As such, when the coil springs 152 and 154 having different spring constants are disposed at both ends of the mass member 120, deflecting the mass member 120 in one direction in the stop state of the mass member 120 may obtain the same as or a similar effect to deflecting the magnet member 130.

The bearing member 160 may be disposed between the housing 110 and the mass member 120 and may be mounted in the housing 110 or the mass member 120. In other words, the bearing member 160 may be disposed between the inner circumferential surface of the housing 110 and an outer circumferential surface of the mass member 120. The bearing member 160, so disposed, relieves contact and friction between the inner circumferential surface of the housing 110 and the outer circumferential surface of the mass member 120, thereby allowing for reciprocation of the mass member 120 to be smooth.

According to the horizontal linear vibrator 100 configured as described above, the moving position of the mass member 120 may be stably maintained by the elastic member 150 and the bearing member 160 to stably secure straightness of the mass member 120, thereby obtaining a constant and reliable vibrational frequency. Further, the horizontal linear vibrator 100 according to the embodiment of the present invention may prevent or relieve the collision phenomenon between the mass member 120 and the housing 110 due to the elastic member 150 and the bearing member 160, thereby improving durability against external impact.

Next, a horizontal linear vibrator according to another embodiment of the present invention will be described. For reference, in describing the following embodiments, components that are the same as those of the above-mentioned embodiment of the present invention will be denoted by the same reference numerals as the foregoing embodiments and a detailed description thereof will be omitted.

Hereinafter, a horizontal linear vibrator according to a second embodiment of the present invention will be described with reference to FIG. 4.

The horizontal linear vibrator 100 according to the embodiment of the present invention may be differentiated from the first embodiment in terms of the positions of the magnet member 130 and the coil member 140. In other words, according to the embodiment of the present invention, the magnet member 130 may be mounted on the inner circumferential surface of the housing 110 and the coil member 140 may be mounted on the outer circumferential surface of the mass member 120.

The so configured horizontal linear vibrator 100 has a structure in which the coil member 140 is wound around the mass member 120 separable from the housing 110, such that the coil member 140 may be mounted relatively easily.

Next, a horizontal linear vibrator according to a third embodiment of the present invention will be described with reference FIGS. 5 through 8.

The horizontal linear vibrator 100 according to the embodiment of the present invention may be differentiated from the foregoing embodiments in terms of the shapes of the housing 110 and the mass member 120. In other words, according to the embodiment of the present invention, the housing 110 may be provided with the groove 114 and the mass member 120 may be provided with a protrusion 124.

The groove 114 may be formed lengthily in the length direction of the housing 110. In other words, the groove 114 may be formed lengthily in the reciprocating motion direction (horizontal direction based on FIG. 5) of the mass member 120.

The protrusion 124 may be formed in the mass member 120. In other words, the protrusions 124 may be formed lengthily in the reciprocating motion direction of the mass member 120. Alternatively, the plurality of protrusions 124 may be formed along the reciprocating motion direction of the mass member 120 at a predetermined distance. The protrusion 124 may be inserted into the groove 114 of the housing 110. In other words, the protrusion 124 has a size which substantially coincides with the groove 114 and may move along the groove 114 in the significantly reduced contact friction state. That is, the protrusion 124 and the groove 114 are precisely machined with a significantly reduced tolerance, and therefore may slidably contact each other.

According to the horizontal linear vibrator 100 configured as described above, the straightness of the mass member 120 may be secured by the protrusion 124 inserted into the groove 114. Therefore, in the present embodiment, the bearing member 160 may be omitted, such that the manufacturing costs of the horizontal linear vibrator 100 may be saved and the manufacturing process thereof may be simplified.

Meanwhile, as illustrated in FIGS. 7 and 8, the plurality of grooves 114 and the plurality of protrusions 124 may be formed in the circumference of the housing 110 and the mass member 120 at a predetermined distance.

Next, a horizontal linear vibrator according to a fourth embodiment of the present invention will be described with reference FIGS. 9 through 12.

The horizontal linear vibrator 100 according to the embodiment of the present invention may be differentiated from the foregoing embodiments in terms of the cross-sectional shapes of the housing 110 and the mass member 120.

In the present embodiment, the housing 110 may have a vertical or horizontal asymmetrical cross-sectional shape, a rectangular or squared cross-sectional shape, or a polygonal or oval cross-sectional shape. In other words, as illustrated in FIG. 10, the housing 110 may have a cross-sectional shape in which a portion of a circle is flat. Alternatively, as illustrated in FIG. 11, the housing 110 may have a rectangular cross-sectional shape. Alternatively, as illustrated in FIG. 12, the housing 110 may have an oval cross-sectional shape. That is, in the present embodiment, the housing 110 may have a cross-sectional shape having directivity.

The mass member 120 may have a cross-sectional shape corresponding to the housing 110. That is, the mass member 120 illustrated in FIG. 10 may have the cross-sectional shape which coincides with a shape in which the housing 110 is reduced at a predetermined ratio, the mass member 120 illustrated in FIG. 11 may have a rectangular or squared cross-sectional shape, and the mass member 120 illustrated in FIG. 12 may have an oval cross-sectional shape.

The cross-sectional shapes of the housing 110 and the mass member 120 having the above-mentioned shape have directivity, such that the mass member 120 may be deflected in a specific direction within the housing 110. That is, the structure serves to restrict the motion of the mass member 120 in the section, thereby improving the straightness of the mass member 120.

As set forth above, according to the embodiments of the present invention, the high-frequency vibrations may be generated by forming the mass member to have an appropriate size.

Further, according to the embodiments of the present invention, the manufacturing costs of the horizontal linear vibrator may be saved by significantly reducing the number of components of the horizontal linear vibrator.

In addition, according to the embodiments of the present invention, since the internal structure of the horizontal linear vibrator is robust, an influence on the performance of the horizontal linear vibrator due to the external impact may be significantly reduced.

While the present invention has been shown and described in connection with the embodiments, it will be apparent to those skilled in the art that modifications and variations can be made without departing from the spirit and scope of the invention as defined by the appended claims.

What is claimed is:

1. A horizontal linear vibrator, comprising:
a housing;
a mass member movably mounted within the housing in a length direction thereof;
a coil member mounted in the housing;
a magnet member mounted in the mass member and interacting with the coil member to generate a magnetic field so as to enable movement of the mass member;
an elastic member mounted in the housing and applying force in the same direction as or an opposite direction to a moving direction of the mass member; and
a bearing member disposed between the mass member and the housing to enable a sliding motion of the mass member relative to the housing.

2. The horizontal linear vibrator of claim 1, wherein the elastic member is a coil spring.

3. The horizontal linear vibrator of claim 1, wherein the elastic member includes:
a first spring connecting one end of the housing to one end of the mass member; and
a second spring connecting the other end of the housing to the other end of the mass member.

4. The horizontal linear vibrator of claim 3, wherein the first spring and the second spring have different spring constants.

5. The horizontal linear vibrator of claim 1, wherein the housing has a cylindrical shape having a circular cross-section, and
the mass member has a cylindrical shape having a circular cross-section.

6. The horizontal linear vibrator of claim 1, wherein the magnet member is disposed to be deflected in one direction from a center of a magnetic field of the coil member to provide a deflected magnetic field to the coil member in a state in which the mass member stops.

7. A horizontal linear vibrator, comprising:
a housing;
a mass member movably mounted within the housing in a length direction thereof;
a magnet member mounted in the housing;
a coil member mounted in the mass member and interacting with the magnet member to generate a magnetic field so as to enable movement of the mass member;
an elastic member mounted in the housing and applying force in the same direction as or an opposite direction to a moving direction of the mass member; and
a bearing member disposed between the mass member and the housing to enable a sliding motion of the mass member relative to the housing.

8. The horizontal linear vibrator of claim 7, wherein the elastic member is a coil spring.

9. The horizontal linear vibrator of claim 7, wherein the elastic member includes:
a first spring connecting one end of the housing to one end of the mass member; and
a second spring connecting the other end of the housing to the other end of the mass member.

10. The horizontal linear vibrator of claim 9, wherein the first spring and the second spring have different spring constants.

11. The horizontal linear vibrator of claim 7, wherein the housing has a cylindrical shape having a circular cross-section, and
the mass member has a cylindrical shape having a circular cross-section.

12. The horizontal linear vibrator of claim 7, wherein the magnet member is disposed to be deflected in one direction from a center of a magnetic field of the coil member to provide a deflected magnetic field to the coil member in a state in which the mass member stops.

13. A horizontal linear vibrator, comprising:
a housing provided with a groove extending lengthily in a length direction;
a mass member movably mounted within the housing in a length direction thereof and provided with a protrusion inserted into the groove;
a coil member mounted in the housing;
a magnet member mounted in the mass member and interacting with the coil member to generate a magnetic field so as to enable movement of the mass member; and
an elastic member mounted in the housing and applying force in the same direction as or an opposite direction to a moving direction of the mass member.

14. The horizontal linear vibrator of claim 13, wherein the elastic member is a coil spring.

15. The horizontal linear vibrator of claim 13, wherein the elastic member includes:
a first spring connecting one end of the housing to one end of the mass member; and
a second spring connecting the other end of the housing to the other end of the mass member.

16. The horizontal linear vibrator of claim 15, wherein the first spring and the second spring have different spring constants.

17. The horizontal linear vibrator of claim 13, wherein the housing has a cylindrical shape having a circular cross-section, and
the mass member has a cylindrical shape having a circular cross-section.

18. The horizontal linear vibrator of claim. 13, wherein the magnet member is disposed to be deflected in one direction from a center of a magnetic field of the coil member to provide a deflected magnetic field to the coil member in a state in which the mass member stops.

19. A horizontal linear vibrator, comprising:
a housing having a receiving space extending in a length direction;
a mass member mounted in the receiving space and movable along the length direction;
a coil member mounted in the housing;
a magnet member mounted in the mass member and interacting with the coil member to generate a magnetic field so as to enable movement of the mass member; and
an elastic member mounted in the housing and applying force in the same direction as or an opposite direction to a moving direction of the mass member,
wherein the receiving space has an asymmetrical cross-section or an oval or polygonal cross-section, and
the mass member has a cross-sectional shape coinciding with a section of the receiving space.

20. The horizontal linear vibrator of claim 19, wherein the elastic member is a coil spring.

21. The horizontal linear vibrator of claim 19, wherein the elastic member includes:
a first spring connecting one end of the housing to one end of the mass member; and
a second spring connecting the other end of the housing to the other end of the mass member.

22. The horizontal linear vibrator of claim 21, wherein the first spring and the second spring have different spring constants.

23. The horizontal linear vibrator of claim 19, wherein the magnet member is disposed to be deflected in one direction from a center of a magnetic field of the coil member to provide a deflected magnetic field to the coil member in a state in which the mass member stops.
